(19) United States
(12) Patent Application Publication
(10) Pub. No.: US 2024/0331911 A1
(43) Pub. Date: Oct. 3, 2024

(54) COIL COMPONENT

(71) Applicant: TDK Corporation, Tokyo (JP)

(72) Inventors: Yusuke Nagai, Tokyo (JP); Takahiro Sato, Tokyo (JP); Makoto Yoshino, Tokyo (JP); Hidenobu Umeda, Tokyo (JP); Masaki Takahashi, Tokyo (JP); Yuya Ishima, Tokyo (JP); Kosuke Ito, Tokyo (JP); Keito Yasuda, Tokyo (JP); Takato Sasaki, Tokyo (JP); Takuya Miyashita, Tokyo (JP)

(73) Assignee: TDK Corporation, Tokyo (JP)

(21) Appl. No.: 18/404,288

(22) Filed: Jan. 4, 2024

(30) Foreign Application Priority Data
Mar. 30, 2023 (JP) 2023-055566

(51) Int. Cl. H01F 27/29; H01F 17/00

(52) U.S. Cl. CPC H01F 17/0013; H01F 17/0006; H01F 27/292; H01F 2017/0073

(57) ABSTRACT

A multilayer coil component includes an element body, a coil disposed in the element body, terminal electrodes disposed in the element body, and a first connection conductor and a second connection conductor that connect the coil and the terminal electrodes. A plurality of first pores are provided in the coil, a plurality of second pores are provided in the first connection conductor and the second connection conductor, and an area of the second pore per unit area in the first connection conductor and the second connection conductor is larger than an area of the first pore per unit area in the coil.

### TECHNICAL FIELD

The present disclosure relates to a coil component.

### BACKGROUND

For example, a coil component described in Japanese Unexamined Patent Publication No. 2017-76700 is known as a coil component. The coil component described in Japanese Unexamined Patent Publication No. 2017-76700 includes a rectangular parallelepiped magnetic body portion made of a magnetic material, a coil disposed inside the magnetic body portion, a pair of terminal electrodes provided in the magnetic body portion and electrically connected to the coil, and a connection conductor connecting the coil and the terminal electrode.

### SUMMARY

An object of an aspect of the present disclosure is to provide a coil component capable of alleviating stress in a connection conductor and suppressing an increase in DC resistance.

(1) A coil component according to an aspect of the present disclosure includes an element body, a coil disposed in the element body, a terminal electrode disposed in the element body, and a connection conductor connecting the coil and the terminal electrode. A plurality of first holes are provided in the coil, a plurality of second holes are provided in the connection conductor, and an area of the second hole per unit area in the connection conductor is larger than an area of the first hole per unit area in the coil.

In the coil component, when an external force (external force at the time of implementation or the like) is applied to the terminal electrode, stress may be applied to the connection conductor connected to the terminal electrode. When stress is applied to the connection conductor, there is a concern that a defect (for example, fault such as breakage) occurs in the connection conductor. In the coil component according to the aspect of the present disclosure, the area of the second coil per unit area in the connection conductor is larger than the area of the first hole per unit area in the coil. As described above, since the connection conductor includes more holes than the coil, the connection conductor has lower rigidity (strength) than the coil and has more flexibility than the coil. Accordingly, in the coil component, stress can be alleviated (absorbed) in the connection conductor. In the coil component, the area of the first hole per unit area in the coil is smaller than the area of the second hole per unit area in the connection conductor. As described above, in the coil component, since the first hole of the coil is smaller than the second hole of the connection conductor, even in a case where the connection conductor includes more second holes, it is possible to suppress an increase in DC resistance of the entire coil component.

(2) In the coil component of the above (1), an average size of the second coils per unit area in the connection conductor may be larger than an average size of the first holes per unit area in the coil. In this configuration, the connection conductor can have flexibility.

(3) In the coil component of the above (1) or (2), resin may be disposed in at least a part of the second holes. In this configuration, in a case where the hardness of the resin is lower than the hardness of the connection conductor, the resin is disposed in the second hole, and thus, it is possible to suppress infiltration of a plating solution to the connection conductor in a manufacturing process of the coil component while the flexibility of the connection conductor is maintained. In a case where the hardness of the resin is higher than the hardness of the connection conductor, the rigidity of the connection conductor can be adjusted by disposing the resin in the second hole.

(4) In the coil component according to any one of the above (1) to (3), in the conduction conductor, the second holes may be disposed in a central region inside a surface of the connection conductor. Q characteristics of the coil component depends on a resistance component of the conductor. In a high frequency range, a current (signal) easily flows near the surface of the conductor due to a skin effect. Accordingly, when the resistance components on the surface of the connection conductor and near the surface increase, the Q characteristics of the coil component decrease. In the coil component, the second hole is disposed in a central region inside the surface of the connection conductor. In this configuration, since a density on the surface side of the connection conductor can be higher than in the central region, the resistance components on the surface of the connection conductor and near the surface can be reduced. Accordingly, in the coil component, the Q characteristics can be improved.

According to the aspect of the present disclosure, the stress can be alleviated in the connection conductor, and the increase in DC resistance can be suppressed.

### BRIEF DESCRIPTION OF THE DRAWINGS

FIG. 1 is a perspective view of a multilayer coil component;

FIG. 2 is a diagram illustrating a cross-sectional configuration of the multilayer coil component illustrated in FIG. 1;

FIG. 3 is a perspective view illustrating a configuration of a coil;

FIG. 4A is a diagram schematically illustrating a cross-sectional configuration of the coil, and FIG. 4B is a diagram schematically illustrating cross-sectional configurations of a first connection conductor and a second connection conductor; and

FIGS. 5A and 5B are diagrams illustrating a central region in a first connection conductor and a second connection conductor.

### DETAILED DESCRIPTION

Hereinafter, preferred embodiments of the present disclosure will be described in detail with reference to the accompanying drawings. Note that, the same or corresponding elements in the description of the drawings are denoted by the same reference signs, and redundant description is omitted.

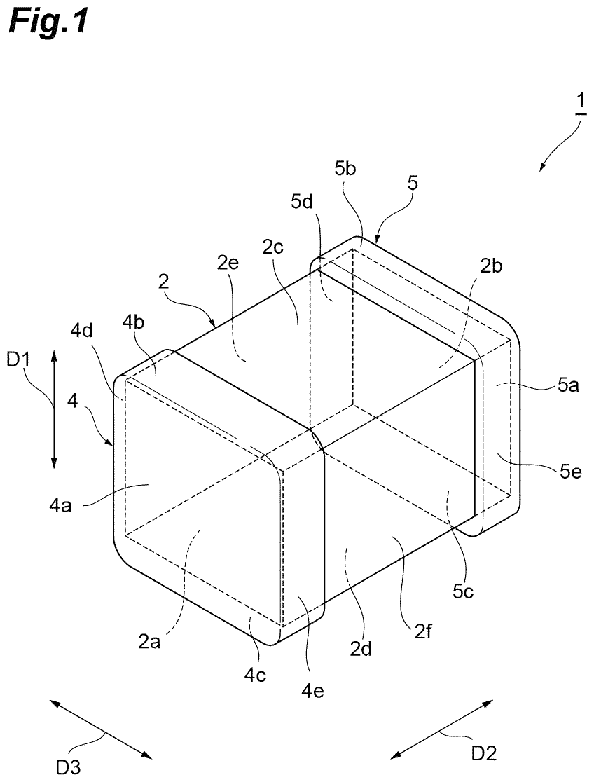

As illustrated in FIG. 1, a multilayer coil component 1 includes an element body 2, and a terminal electrode 4 and a terminal electrode 5 disposed at both end portions of the element body 2, respectively.

The element body 2 has a rectangular parallelepiped shape. The rectangular parallelepiped shape includes a rectangular parallelepiped shape in which corner portions and ridge line portions are chamfered, and a rectangular parallelepiped shape in which corner portions and ridge line portions are rounded. The element body 2 has, as outer surfaces thereof, a pair of end surfaces 2a and 2b facing each other, a pair of principal surfaces 2c and 2d facing each other, and a pair of side surfaces 2e and 2f facing each other. A facing direction in which the pair of principal surfaces 2c and 2d faces each other is a first direction D1. A facing direction in which the pair of end surfaces 2a and 2b faces each other is a second direction D2. A facing direction in which the pair of side surfaces 2e and 2f faces each other is a third direction D3. In the present embodiment, the first direction D1 is a height direction of the element body 2. The second direction D2 is a longitudinal direction of the element body 2, and is orthogonal to the first direction D1. The third direction D3 is a width direction of the element body 2, and is orthogonal to the first direction D1 and the second direction D2.

The pair of end surfaces 2a and 2b extends in the first direction D1 to connect the pair of principal surfaces 2c and 2d. The pair of end surfaces 2a and 2b also extends in the third direction D3 (short side direction of the pair of principal surfaces 2c and 2d). The pair of side surfaces 2e and 2f extends in the first direction D1 to connect the pair of principal surfaces 2c and 2d. The pair of side surfaces 2e and 2f also extends in the second direction D2 (long side direction of the pair of end surfaces 2a and 2b). When the multilayer coil component 1 is implemented on another electronic device (for example, a circuit board, an electronic component, or the like), the principal surface 2d can be defined as an implementation surface facing the other electronic device.

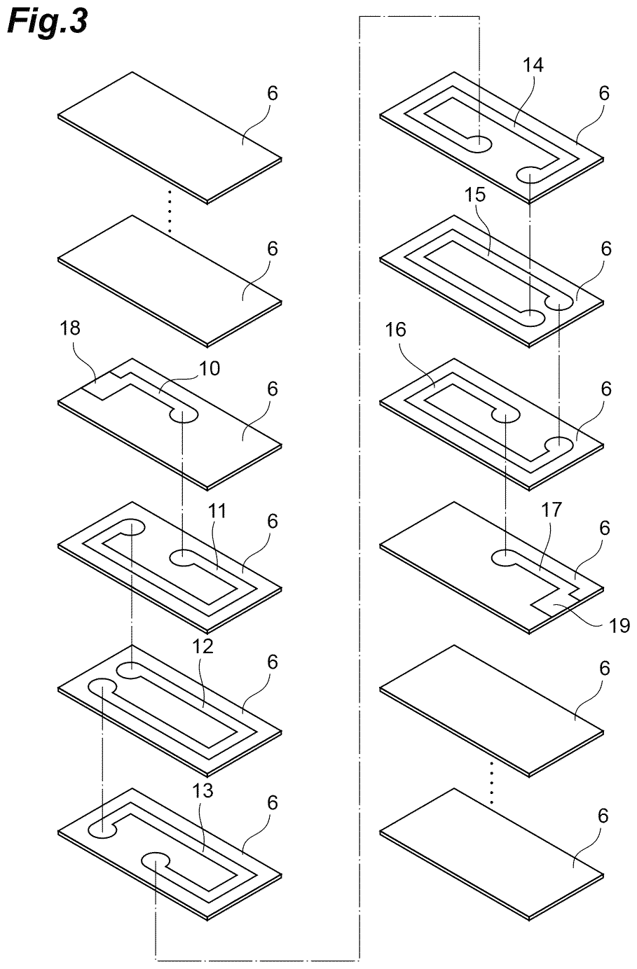

As illustrated in FIG. 3, the element body 2 is formed by stacking a plurality of magnetic layers 6. The magnetic layers 6 are stacked in the first direction D1. That is, the first direction D1 is a stacking direction. The element body 2 has the plurality of stacked magnetic layers 6. In the actual element body 2, the plurality of magnetic layers 6 are integrated to such an extent that boundaries between the layers cannot be visually recognized.

The element body 2 (magnetic layer 6) includes a plurality of metal magnetic particles. The metal magnetic particles include a soft magnetic alloy (soft magnetic material). The soft magnetic alloy is, for example, an Fe—Si-based alloy. In a case where the soft magnetic alloy is an Fe—Si-based alloy, the soft magnetic alloy may contain P. The soft magnetic alloy may be, for example, an Fe—Ni—Si-M-based alloy. “M” includes one or more elements selected from Co, Cr, Mn, P, Ti, Zr, Hf, Nb, Ta, Mo, Mg, Ca, Sr, Ba, Zn, B, Al, and rare earth elements.

In the element body 2, the metal magnetic particles are bonded to each other. The bonding between the metal magnetic particles is realized by, for example, bonding between oxide films formed on surfaces of the metal magnetic particles. A thickness of the oxide film is, for example, equal to or more than 5 nm and equal to or less than 60 nm. The oxide film may include one or a plurality of layers.

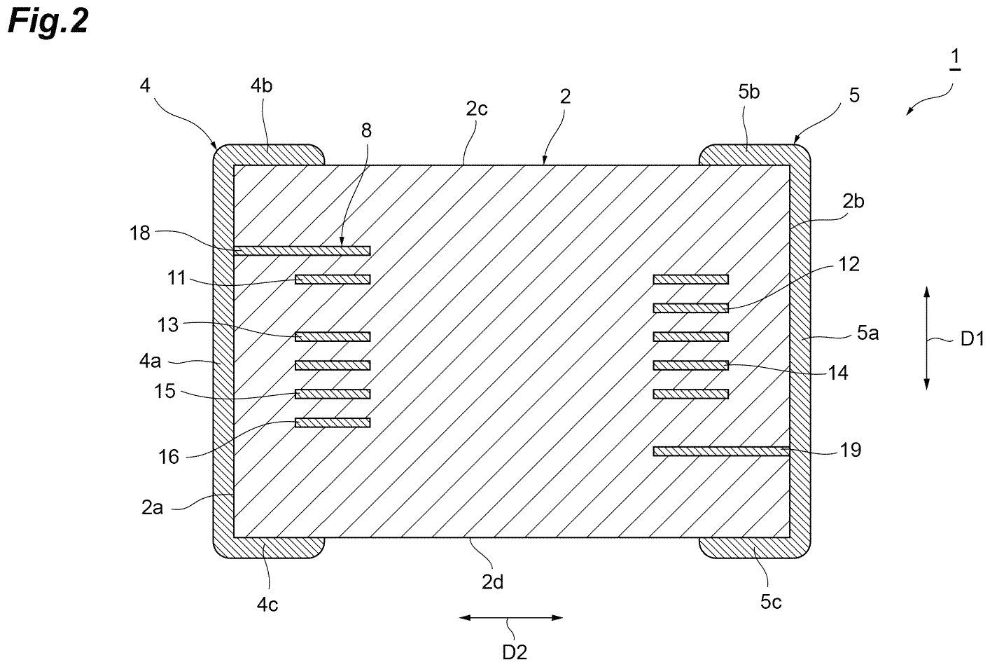

As illustrated in FIGS. 1 and 2, the terminal electrode 4 is disposed on the end surface 2a side of the element body 2, and the terminal electrode 5 is disposed on the end surface 2b side of the element body 2. That is, the terminal electrode 4 and the terminal electrode 5 are positioned apart from each other in the facing direction of the pair of end surfaces 2a and 2b. The terminal electrode 4 and the terminal electrode 5 include a conductive material (for example, Ag or Pd). The terminal electrode 4 and the terminal electrode 5 are formed as a sintered body of a conductive paste containing a conductive metal powder (for example, Ag powder or Pd powder) and glass frit. Electroplating is applied to the terminal electrode 4 and the terminal electrode 5 to form a plating layer on surfaces thereof. For example, Ni, Sn, or the like is used for electroplating.

The terminal electrode 4 is disposed on the one end surface 2a side. The terminal electrode 4 includes five electrode portions including a first electrode portion 4a positioned on the end surface 2a, a second electrode portion 4b positioned on the principal surface 2c, a third electrode portion 4c positioned on the principal surface 2d, a fourth electrode portion 4d positioned on the side surface 2e, and a fifth electrode portion 4e positioned on the side surface 2f. The first electrode portion 4a, the second electrode portion 4b, the third electrode portion 4c, the fourth electrode portion 4d, and the fifth electrode portion 4e are connected at a ridge line portion of the element body 2, and are electrically connected to each other. The terminal electrode 4 is formed on five surfaces of one end surface 2a, the pair of principal surfaces 2c and 2d, and the pair of side surfaces 2e and 2f. The first electrode portion 4a, the second electrode portion 4b, the third electrode portion 4c, the fourth electrode portion 4d, and the fifth electrode portion 4e are integrally formed.

In the present embodiment, edges (end surfaces) of the second electrode portion 4b and the third electrode portion 4c of the terminal electrode 4 are, for example, along the third direction D3. An edge of the second electrode portion 4b is linearly formed on the principal surface 2c. The edge of the third electrode portion 4c is linearly formed on the principal surface 2d. Edges of the fourth electrode portion 4d and the fifth electrode portion 4e of the terminal electrode 4 are along the first direction D1. The edge of the fourth electrode portion 4d is linearly formed on the side surface 2e. The edge of the fifth electrode portion 4e is linearly formed on the side surface 2f. Note that, the edges of the second electrode portion 4b, the third electrode portion 4c, the fourth electrode portion 4d, and the fifth electrode portion 4e may be curved or uneven.

The terminal electrode 5 is disposed on the other end surface 2b side. The terminal electrode 5 includes five electrode portions including a first electrode portion 5a positioned on the end surface 2b, a second electrode portion 5b positioned on the principal surface 2c, a third electrode portion 5c positioned on the principal surface 2d, a fourth electrode portion 5d positioned on the side surface 2e, and a fifth electrode portion 5e positioned on the side surface 2f. The first electrode portion 5a, the second electrode portion 5b, the third electrode portion 5c, the fourth electrode portion 5d, and the fifth electrode portion 5e are connected at the ridge line portion of the element body 2, and are electrically connected to each other. The terminal electrode 5 is formed on five surfaces of one end surface 2b, the pair of principal surfaces 2c and 2d, and the pair of side surfaces 2e and 2f. The first electrode portion 5a, the second electrode portion 5b, the third electrode portion 5c, the fourth electrode portion 5d, and the fifth electrode portion 5e are integrally formed.

In the present embodiment, edges of the second electrode portion 5b and the third electrode portion 5c of the terminal electrode 5 are, for example, along the third direction D3. The edge of the second electrode portion 5b is linearly formed on the principal surface 2c. The edge of the third electrode portion 5c is linearly formed on the principal surface 2d. Edges of the fourth electrode portion 5d and the fifth electrode portion 5e of the terminal electrode 5 are along the first direction D1. The edge of the fourth electrode portion 5d is linearly formed on the side surface 2e. The edge of the fifth electrode portion 5e is linearly formed on the side surface 2f. Note that, the edges of the second electrode portion 5b, the third electrode portion 5c, the fourth electrode portion 5d, and the fifth electrode portion 5e may be curved or uneven.

As illustrated in FIG. 2, in the multilayer coil component 1, coils 8, a first connection conductor 18, and a second connection conductor 19 are disposed in the element body 2. As illustrated in FIG. 3, the coils 8 are formed in a spiral shape by electrically connecting a plurality of coil conductors 10, 11, 12, 13, 14, 15, 16, and 17 to the first connection conductor 18 and the second connection conductor 19. The coil conductor 10 and the first connection conductor 18 are integrally formed. The coil conductor 17 and the second connection conductor 19 are integrally formed. Adjacent coil conductors 10, 11, 12, 13, 14, 15, 16, and 17 are electrically connected by a through-hole conductor (not illustrated).

Each of the first connection conductor 18 and the second connection conductor 19 has, for example, a rectangular shape. In the present embodiment, each of the first connection conductor 18 and the second connection conductor 19 has a long side along the third direction D3 and a short side along the second direction D2. A thickness direction of the first connection conductor 18 and the second connection conductor 19 is the first direction D1. The first connection conductor 18 is exposed on the end surface 2a of the element body 2 and is connected to the terminal electrode 4 (first electrode portion 4a). The second connection conductor 19 is exposed on the end surface 2b of the element body 2 and is connected to the terminal electrode 5 (first electrode portion 5a).

The coil conductors 10, 11, 12, 13, 14, 15, 16, and 17, the first connection conductor 18, and the second connection conductor 19 are made of a conductive material usually used as a conductor of a coil. For example, Ag, Cu, Au, Al, Pd, a Pd/Ag alloy, or the like can be used as the conductive material. The coil conductors 10, 11, 12, 13, 14, 15, 16, and 17, the first connection conductor 18, and the second connection conductor 19 may be made of the same conductive material, or may be formed of different conductive materials. The coil conductors 10, 11, 12, 13, 14, 15, 16, and 17, the first connection conductor 18, and the second connection conductor 19 are formed as a sintered body of a conductive paste containing the conductive material.

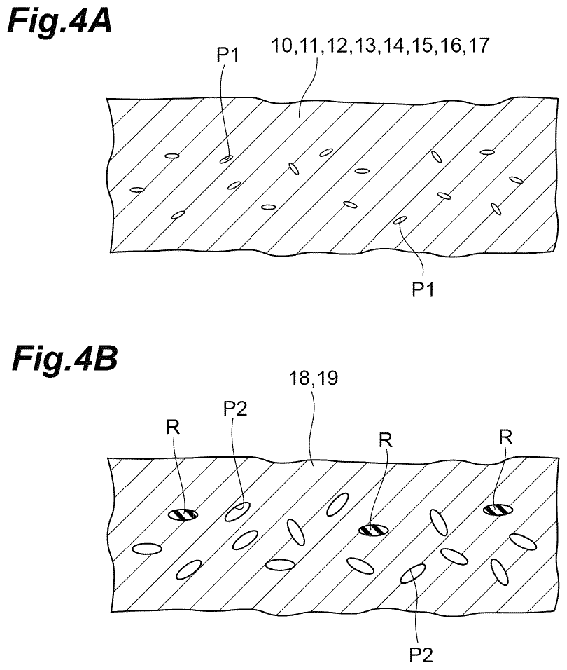

As illustrated in FIG. 4A, a plurality of first pores (first holes) P1 are provided in each of the coils 8 (coil conductors 10, 11, 12, 13, 14, 15, 16, and 17). As illustrated in FIG. 4B, a plurality of second pores (second holes) P2 are provided in each of the first connection conductor 18 and the second connection conductor 19. The first pore P1 and the second pore P2 may be individually provided independently of each other, or the plurality of first pores P1 and second pores P2 may be provided continuously (connected). Shapes of the first pore P1 and the second pore P2 are not particularly limited.

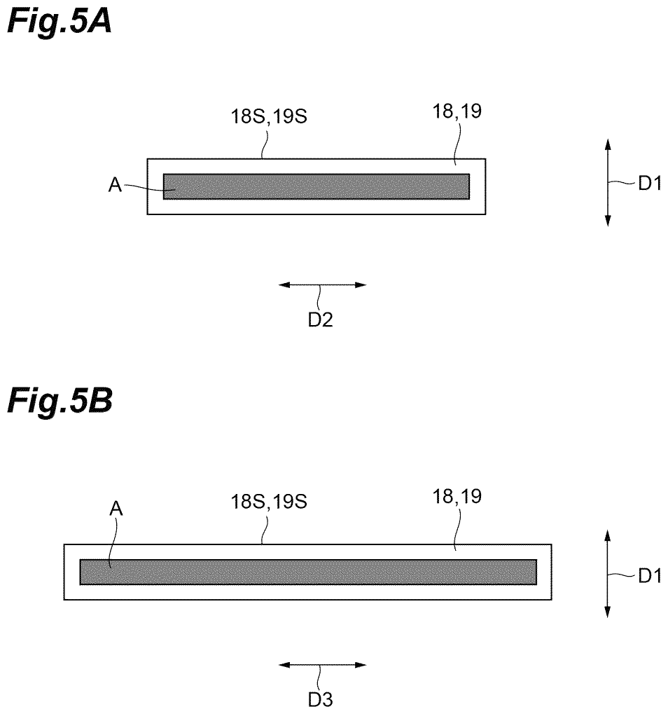

As illustrated in FIGS. 5A and 5B, in each of the first connection conductor 18 and the second connection conductor 19, the plurality of second pores P2 are disposed in a central region A inside surfaces 18S and 19S of the first connection conductor 18 and the second connection conductor 19. The central region A is a position close to a center (middle) in the first direction D1, the second direction D2, and the third direction D3 than the surfaces 18S and 19S in the first connection conductor 18 and the second connection conductor 19. The central region A extends in the second direction D2 and the third direction D3 of each of the first connection conductor 18 and the second connection conductor 19. In the present embodiment, the plurality of second pores P2 are not evenly distributed in the first connection conductor 18 and the second connection conductor 19, and are unevenly distributed in the central region A of each of the first connection conductor 18 and the second connection conductor 19. In each of the first connection conductor 18 and the second connection conductor 19, it can be said that an existence ratio of the second pores P2 is higher in the central region A than in other portions. The second pores P2 may be disposed in positions other than the central region A in each of the first connection conductor 18 and the second connection conductor 19.

In the coil 8, the plurality of first pores P1 may be disposed in a central region inside the surface of the coil 8, or may be evenly distributed in the coil 8. In the present embodiment, it is preferable that the plurality of first pores P1 are disposed in the central region inside the surface of the coil 8.

As illustrated in FIG. 4B, resin R may be disposed in at least some second pores P2 of the plurality of second pores P2. The resin R may be disposed (filled) in all the second pores P2 or may be disposed in a part of the second pores P2. The resin R is, for example, a resin having electrical insulation properties, that is, an insulating resin. The insulating resin includes, for example, a silicone resin, a phenol resin, an acrylic resin, or an epoxy resin. The hardness of the resin R may be lower than the hardness of the first connection conductor 18 and the second connection conductor 19, or may be higher than the hardness of the first connection conductor 18 and the second connection conductor 19. In the example illustrated in FIG. 4B, the resin R having lower hardness than the first connection conductor 18 and the second connection conductor 19 is disposed in a part of the plurality of second pores P2. Note that, resin (not illustrated) may also be disposed in at least some first pores P1 of the plurality of first pores P1.

An area of the second pore P2 per unit area in each of the first connection conductor 18 and the second connection conductor 19 is larger than an area of the first pore P1 per unit area in the coil 8 (coil conductors 10, 11, 12, 13, 14, 15, or 16). That is, the first connection conductor 18 and the second connection conductor 19 include more pores than the coil 8. It can also be said that a volume of the second pore P2 per unit volume in the first connection conductor 18 and the second connection conductor 19 is larger than a volume of the first pore P1 per unit volume of the coil 8. A volume density of the second pore P2 in the first connection conductor 18 and the second connection conductor 19 is higher than a volume density of the first pore P1 in the coil 8. The volume density means a volume occupied by the pore per unit volume.

The first connection conductor 18 and the second connection conductor 19 include more pores than the coil 8. As a result, a density per unit volume of the first connection conductor 18 and the second connection conductor 19 is sparser than the coil 8. Thus, it can be said that the density per unit volume of the first connection conductor 18 and the second connection conductor 19 is lower than the density per unit volume of the coil 8.

An average size of the second pores P2 is larger than an average size of the first pores P1. An average size of the first pores P1 is, for example, equal to or more than 0.1 μm and equal to or less than 2.0 μm, and preferably equal to or more than 0.5 μm and equal to or less than 1.0 μm. The average size of the second pores P2 is, for example, equal to or more than 1.0 μm and equal to or less than 10.0 μm, and preferably equal to or more than 2.0 μm and equal to or less than 5.0 μm. The average size of the second pores P2 is, for example, equal to or more than 1.1 times and equal to or less than 10 times the average size of the first pore P1.

The average size of each of the first pore P1 and the second pore P2 is obtained, for example, as follows. A cross-sectional photograph of the multilayer coil component 1 including the coil 8, the first connection conductor 18, and the second connection conductor 19 is acquired. The cross-sectional photograph is obtained, for example, by imaging a cross section when the multilayer coil component 1 is cut on a plane parallel to the pair of side surfaces 2e and 2f and separated from the pair of side surfaces 2e and 2f by a predetermined distance. In this case, the plane may be positioned at an equal distance from the pair of side surfaces 2e and 2f. Image processing is performed on the acquired cross-sectional photograph by software. A boundary between the first pore P1 and the second pore P2 is discriminated by the image processing, and the areas of the first pore P1 and the second pore P2 are obtained. A size (diameter) converted into an equivalent circle diameter is obtained from the obtained areas of the first pore P1 and the second pore P2. Here, sizes of 100 or more pores are calculated for each of the first pore P1 and the second pore P2 to obtain a distribution. A diameter (d 50) at an integrated value of 50% in the obtained distribution is taken as an “average size”.

Next, a method for manufacturing the multilayer coil component 1 will be described.

Metal magnetic particles, an insulating resin, a solvent, and the like are mixed to prepare a slurry. The prepared slurry is applied onto a substrate (for example, a PET film or the like) by a doctor blade method to form green sheets to be the magnetic layers 6. Subsequently, through-holes are formed at expected formation positions of through-hole conductors in the green sheets by laser processing.

Subsequently, a first conductive paste is filled in the through-holes of the green sheets. The first conductive paste is prepared by mixing a conductive metal powder, a binder resin, and the like. Subsequently, conductors to be the coil conductors 10, 11, 12, 13, 14, 15, 16, and 17, the first connection conductor 18, and the second connection conductor 19 are provided on the green sheet. At this time, the conductors are connected to the conductive paste in the through-holes.

The coil conductors 10, 11, 12, 13, 14, 15, 16, and 17 are formed by using the first conductive paste by, for example, a screen printing method. The first connection conductor 18 and the second connection conductor 19 are formed by using a second conductive paste by, for example, a screen printing method. The second conductive paste is prepared by mixing a conductive metal powder, a binder resin, and the like. The second conductive paste contains more binder resins than the first conductive paste.

Subsequently, the green sheets are stacked. Here, a stacked body is formed by stacking the plurality of green sheets on which the conductors are provided after being peeled from the substrate and pressing the stacked green sheets in the stacking direction. At this time, the green sheets are stacked such that the conductors to be the coil conductors 10, 11, 12, 13, 14, 15, 16, and 17, the first connection conductor 18, and the second connection conductor 19 overlap in the stacking direction.

Subsequently, green chips are obtained by cutting the stacked body of the green sheets into chips each having a predetermined size with a cutting machine. Subsequently, the green chips are fired. The binder resin contained in each part is removed (decomposed) by firing. Since the second conductive paste has a larger content of the binder resin than the first conductive paste, when the binder resin is removed, more pores are formed in the first connection conductor 18 and the second connection conductor 19 than in the coil conductors 10, 11, 12, 13, 14, 15, 16, and 17. As a result, the first pores P1 are formed in the coil conductors 10, 11, 12, 13, 14, 15, 16, and 17, and the second pores P2 are formed in the first connection conductor 18 and the second connection conductor 19. Subsequently, the chip components are immersed in a resin liquid, and the chip components are impregnated with the resin. As described above, the element body 2 is obtained.

Subsequently, a third conductive paste to be the terminal electrode 4 and the terminal electrode 5 is provided at both the end portions of the element body 2 by, for example, a dip method. The third conductive paste is prepared by mixing a conductive metal powder, a binder resin, and the like. Subsequently, a baked electrode is formed by baking the third conductive paste by heat treatment. Finally, a surface of the baked electrode is plated to form a plating layer. Through the above processes, the multilayer coil component 1 is obtained.

As described above, in the multilayer coil component 1 according to the present embodiment, an area per unit area of the second pore P2 in the first connection conductor 18 and the second connection conductor 19 is larger than an area per unit area of the first pore P1 in the coil 8. As described above, since the first connection conductor 18 and the second connection conductor 19 include more holes than the coil 8, rigidity (strength) is lower than the coil 8, and flexibility is higher than the coil 8. Accordingly, in the multilayer coil component 1, stress can be alleviated (absorbed) in the first connection conductor 18 and the second connection conductor 19. In the multilayer coil component 1, the area per unit area of the first pore P1 in the coil 8 is smaller than the area per unit area of the second pore P2 in the first connection conductor 18 and the second connection conductor 19. As described above, in the multilayer coil component 1, since the first pore P1 of the coil 8 is smaller than the second pore P2 of the first connection conductor 18 and the second connection conductor 19, even in a case where the first connection conductor 18 and the second connection conductor 19 include a large number of second pores P2, it is possible to suppress an increase in a DC resistance as the whole multilayer coil component 1.

In the multilayer coil component 1 according to the present embodiment, an average size of the second pores P2 per unit area in the first connection conductor 18 and the second connection conductor 19 is larger than an average size of the first pores P1 per unit area in the coil 8. In this configuration, the first connection conductor 18 and the second connection conductor 19 can have flexibility.

In the multilayer coil component 1 according to the present embodiment, the resin R may be disposed in at least a part of the second pores P2. In this configuration, in a case where the hardness of the resin R is lower than the hardness of the first connection conductor 18 and the second connection conductor 19, the resin R is disposed in the second pores P2, and thus, it is possible to suppress infiltration of a plating solution to the first connection conductor 18 and the second connection conductor 19 in a manufacturing process of the multilayer coil component 1 while the flexibility of the first connection conductor 18 and the second connection conductor 19 are maintained. In a case where the hardness of the resin R is higher than the hardness of the first connection conductor 18 and the second connection conductor 19, the resin R is disposed in the second pores P2, and thus, the rigidity of the first connection conductor 18 and the second connection conductor 19 can be adjusted.

In the multilayer coil component 1 according to the present embodiment, in the first connection conductor 18 and the second connection conductor 19, the second pores P2 are disposed in the central region A inside the surfaces 18S and 19S of the first connection conductor 18 and the second connection conductor 19. Q characteristics of the multilayer coil component 1 depend on resistance components of the conductors. In a high frequency range, a current (signal) easily flows near the surface of the conductor due to a skin effect. Accordingly, when the resistance components on the surfaces 18S and 19S of the first connection conductor 18 and the second connection conductor 19 and near the surfaces 18S and 19S increase, the Q characteristics of the multilayer coil component 1 decrease. In the multilayer coil component 1, the second pores P2 are disposed in the central region A inside the surfaces 18S and 19S of the first connection conductor 18 and the second connection conductor 19. In this configuration, since the density on the surfaces 18S and 19S sides of the first connection conductor 18 and the second connection conductor 19 can be set to be higher than the central region A, the resistance components on the surfaces 18S and 19S and near the surfaces 18S and 19S of the first connection conductor 18 and the second connection conductor 19 can be reduced. Accordingly, in the multilayer coil component 1, the Q characteristics can be improved.

Although the embodiment of the present disclosure has been described above, the present disclosure is not necessarily limited to the above-described embodiment, and various modifications can be made without departing from the gist thereof.

In the above embodiment, a mode in which the element body 2 (magnetic layer 6) contains the plurality of metal magnetic particles has been described as an example. However, the element body 2 may not contain the metal magnetic particles.

In the above embodiment, a mode in which the coils 8 include the coil conductors 10, 11, 12, 13, 14, 15, 16, and 17 has been described as an example. However, the number and shape of the coil conductors constituting the coils are not limited.

In the above embodiment, a mode in which the terminal electrode 4 includes the first electrode portion 4a, the second electrode portion 4b, the third electrode portion 4c, the fourth electrode portion 4d, and the fifth electrode portion 4e, and the terminal electrode 5 includes the first electrode portion 5a, the second electrode portion 5b, the third electrode portion 5c, the fourth electrode portion 5d, and the fifth electrode portion 5e has been described as an example. However, the terminal electrodes may be disposed only on the end surfaces 2a and 2b of the element body 2, or may be disposed over the end surfaces 2a and 2b and the principal surface 2d of the element body 2 (L-shaped terminals).

What is claimed is:

1. A coil component comprising:
an element body;
a coil disposed in the element body;
a terminal electrode disposed in the element body; and
a connection conductor connecting the coil and the terminal electrode,
wherein
a plurality of first holes are provided in the coil,
a plurality of second holes are provided in the connection conductor, and
an area of the second hole per unit area in the connection conductor is larger than an area of the first hole per unit area in the coil.

2. The coil component according to claim 1, wherein an average size of the second holes per unit area in the connection conductor is larger than an average size of the first holes per unit area in the coil.

3. The coil component according to claim 1, wherein resin is disposed in at least a part of the second holes.

4. The coil component according to claim 1, wherein, in the connection conductor, the second holes are disposed in a central region inside a surface of the connection conductor.
